(19) United States
(12) Patent Application Publication
(10) Pub. No.: US 2024/0283053 A1
(43) Pub. Date: Aug. 22, 2024

(54) BATTERY COOLING SYSTEM

(71) Applicant: FUJI BELLOWS CO., LTD, Ayase-shi, Kanagawa (JP)

(72) Inventor: Ken TAKAHASHI, Kanagawa (JP)

(21) Appl. No.: 18/567,480

(22) PCT Filed: Dec. 27, 2022
(86) PCT No.: PCT/JP2022/048137

§ 371 Date: Dec. 6, 2023

(30) Foreign Application Priority Data
Mar. 17, 2022 (JP) 2022-043228

(51) Int. Cl. H01M 10/6568; B60H 1/00; H01M 10/613; H01M 10/625; H01M 10/637

(52) U.S. Cl. CPC H01M 10/6568; B60H 1/00278; B60H 1/00392; H01M 10/613; H01M 10/625; H01M 10/637; H01M 2220/20

(57) ABSTRACT

A battery cooling system (1) configured to distribute a cooling medium at an appropriate flow rate. The battery cooling system cools a battery including a plurality of battery packs (3) by a jacket (2). The jacket includes a branch channel (supply branch channel 12, discharge branch channel 13) that branches from a main channel (supply main channel 10, discharge main channel 11) and returns to the main channel. The main channel is directly coupled to pressure feeding pump (P) that pressure feeds a cooling medium. The battery cooling system includes a temperature control valve (5, 5′, 5″) provided at the branch channel through which the cooling medium flows out from the channel of the jacket to an outside and returns to the main channel. The temperature control valve adjusts a degree of opening of a valve corresponding to a temperature of the cooling medium nearby.

### TECHNICAL FIELD

The present invention relates to a battery cooling system, and specifically, relates to a battery cooling system that cools a battery including a plurality of battery packs by a jacket with a branch channel that branches from a main channel and returns to the main channel directly connected to pressure feeding means, such as a pump and a fan, that pressure feeds a cooling medium.

### BACKGROUND ART

Recently, demand for batteries in power application typified by electric vehicles and power tools is increasing, and in a battery in which battery packs including a plurality of cells are integrated, the heat generation amount of the battery tends to become large due to the large conducting current in the case of the power application. Since use of the battery at high temperature accelerates deterioration, it is necessary to reduce the output from the battery or decrease the charging speed for protecting the battery.

However, since a plurality of battery packs are series-connected, the output or the charging speed needs to be reduced in the whole battery. Therefore, it is necessary to surely cool each of the battery packs by any cooling system to make temperatures of the individual battery packs uniform.

That is, since the battery pack is temperature dependent, and the battery temperature significantly affects the battery life, in the case of a battery of battery packs including a plurality of cells, it is important to attempt making battery temperatures of the respective cells uniform. For cooling the battery and making temperatures uniform, a method in which a flow passage of a cooling medium is provided in a battery pack, and it is driven by an electric pump or an electric fan to flow the cooling medium has been generally used.

For example, Patent Document 1 discloses a battery cooling device for an electric vehicle including a battery (13) for driving the electric vehicle, a cooling member (14) internally including cooling medium flow passages (14a, 14b), a cooling medium supply piping (15) that supplies the cooling medium to the cooling member (14), and a cooling medium discharge piping (16) that discharges the cooling medium from the cooling member (14) (see claim 1 in claims, paragraphs to in Description, FIG. 1 to FIG. 8 in Drawings, and the like of Patent Document 1).

The battery cooling device includes a cooling medium jacket (14) that is integrally formed with a battery case (12) and internally includes the cooling medium flow passages (14a, 14b). The cooling medium supplied from the cooling medium supply piping (15) branches from the cooling medium inlet (20) of the pair of cooling medium jackets (14) positioned at the frontmost position toward the cooling medium supply passages (14a) on the left and right sides, flows outward in the vehicle width direction, makes a U-turn in the communication chambers (23), flows inward in the vehicle width direction in the cooling medium discharge passages (14b) on the left and right sides, is combined in the cooling medium outlet (21), and is returned to the cooling medium discharge piping (16) (see paragraph of Description of Patent Document 1).

In the battery cooling device of Patent Document 1, since the internal diameter d1 of the cooling medium inlets (20) and the cooling medium outlets (21) of the three pairs of cooling medium jackets (14) on the upstream side is set to be small, and the internal diameter d2 of the cooling medium inlets (20) and the cooling medium outlets (21) of the three pairs of cooling medium jackets (14) on the downstream side is set to be large, it is possible by making the amount of cooling medium supplied to the six pairs of cooling medium jackets (14) uniform to evenly cool all of the battery modules (13) (see paragraph of Description of Patent Document 1).

However, in the method of making the flow rate of the cooling medium uniform by the water flow resistance due to the internal diameter, the orifice, or the like, of the cooling medium passage, actually, there is a problem that the flow rate of cooling water flowing into the respective jackets varies due to variation in passage area, bends, and the like. Moreover, actually, there is a problem that variation occurs in temperatures of the respective battery packs because of variation in heat generation amount due to the product error of the battery pack, and it is impossible to make the temperatures of all of the battery packs uniform only by making the water flow resistances uniform.

Patent Document 2 discloses a cooling system that includes a plurality of coolers (30, 31, 32, 33) including heat exchanging units (300, 310, 320, 330) configured to cool batteries by heat exchange between a cooling medium flowing inside and the batteries (20), and a cooling medium supply passage (W20) that supplies the cooling medium to the plurality of coolers (see claim 1 in claims, paragraphs to in Description, FIG. 1 to FIG. 3 in Drawings, and the like of Patent Document 2).

The cooling medium supply passage of the cooling system disclosed in Patent Document 2 is provided with a main flow channel (W21) through which the cooling medium flows and a plurality of branch flow channels (W22a, W22b, W22c, W22d) that branch from the main flow channel (W21) and distribute the cooling medium to the plurality of coolers (30, 31, 32, 33), respectively. With the coolers (30, 31, 32, 33) provided at the plurality of branch flow channels (W22a, W22b, W22c, W22d), respectively, the cooling medium is supplied to the plurality of coolers (30, 31, 32, 33) in parallel.

Then, also in the cooling system disclosed in Patent Document 2, similarly to the battery cooling device of Patent Document 1, when a portion branched from the main flow channel (W21) into the branch flow channels (W22a, W22b, W22c, W22d) at the cooling medium supply passage is assumed as a branching portion (Pb), orifices (301, 311, 321, 331) are provided at portions from the branching portion (Pb) to the heat exchanging units (300, 310, 320, 330) to make the flow rates of the cooling medium uniform by the water flow resistance.

However, in the cooling system disclosed in Patent Document 2, similarly to the battery cooling device of Patent Document 1, the problem that the flow rate of cooling water flowing into the respective jackets varies due to variation in passage area, bends, and the like, and the problem that variation occurs in temperatures of the respective battery packs because of variation in heat generation amount due to the product error of the battery pack have not been solved.

Patent Document 3 discloses a cooling system including a common channel through which a cooling medium flows, a plurality of branch channels that are coupled to the common channel and each supply the cooling medium to one or more cooling targets, and at least one EHD flow rate adjusting device that adjusts amounts of the cooling medium flowing into the respective branch channels (see claim 1 in claims, paragraphs to in Description, FIG. 1 to FIG. 6 in Drawings, and the like of Patent Document 3).

However, the cooling system disclosed in Patent Document 3 is one in which the flow rate of the cooling medium is adjusted with the EHD flow rate adjusting device, and there is a problem that a complicated control is necessary, and the system is unsuitable for a mechanism, such as an electric vehicle, in which vibration possibly causes a malfunction leading to a serious accident because of lack of durability and reliability.
Patent Document 1: JP-A-2019-186149
Patent Document 2: JP-A-2020-140955
Patent Document 3: JP-A-2020-173964

### DISCLOSURE OF THE INVENTION

### Problems to be Solved by the Invention

Therefore, the present invention has been made to solve the above-described problems, and an object of the present invention is to provide a battery cooling system configured to distribute a cooling medium at an appropriate flow rate by increasing and decreasing a flow resistance of the cooling medium corresponding to a heat generation amount of each of battery packs with a mechanism that is low-price, simple, and highly durable and reliable with little malfunction.

### Solutions to the Problems

A battery cooling system according to a first invention is a battery cooling system for cooling a battery including a plurality of battery packs by a jacket. The jacket includes a branch channel that branches from a main channel and returns to the main channel. The main channel is directly coupled to pressure feeding means that pressure feeds a cooling medium. The battery cooling system includes a temperature control valve provided at the branch channel through which the cooling medium flows out from the channel of the jacket to an outside and returns to the main channel. The self-powered temperature control valve adjusts a degree of opening of a valve corresponding to a temperature of the cooling medium nearby.

In a battery cooling system according to a second invention, which is in the first invention, the temperature control valve is a wax-type thermostat.

In a battery cooling system according to a third invention, which is in the first invention, the temperature control valve is a bellows-type thermostat.

In a battery cooling system according to a fourth invention, which is in the first invention, the temperature control valve is an SMA-type thermostat.

In a battery cooling system according to a fifth invention, which is in any of the first invention to the fourth invention, the temperature control valve is provided with a leak hole.

In a battery cooling system according to a sixth invention, which is in the fifth invention, the leak hole is a leak groove formed at a part of a valve seat or a valve element.

In a battery cooling system according to a seventh invention, which is in any of the first invention to the sixth invention, a pressure relief structure is provided.

### Effects of the Invention

According to the first invention to the seventh invention, the flow resistance of the cooling medium can be increased and decreased corresponding to the heat generation amounts of the respective battery packs, and the cooling medium can be distributed at the appropriate flow rate, thus allowing uniformly controlling the battery temperatures of the respective cells. Therefore, the life of the battery pack and the battery can be prolonged and the durability can be improved.

According to the first invention to the seventh invention, since the above-described operational advantage is achieved with the temperature control valve that has been proven for long years as cooling means for internal combustion engines of an automobile and the like in which vibration possibly causes a malfunction leading to a serious accident, one that is low-price, simple, and highly durable and reliable with little malfunction is provided.

Especially, according to the fifth invention, since the leak hole is configured to always flow the cooling medium by a constant amount, and the temperature of the cooling medium is always measured, the temperatures of the individual battery packs can be always monitored.

Especially, according to the sixth invention, even when the leak hole is clogged with a foreign matter, by opening the valve, the foreign matter can be flowed out by the cooling medium and removed.

Especially, according to the seventh invention, since the pressure relief structure is provided, even in a temperature range before opening the valve of the thermostat, the output of the pump that pressure feeds the cooling medium can be increased as necessary to flow the cooling medium.

### BRIEF DESCRIPTION OF THE DRAWINGS

FIG. 1 is a schematic plan view schematically illustrating a configuration of a battery cooling system according to an embodiment of the present invention.

FIG. 2 is a cross-sectional view illustrating a configuration of a temperature control valve according to a first embodiment of the present invention.

FIG. 3 is an explanatory view of a first open state illustrating a valve open state by temperature sensing of the temperature control valve.

FIG. 4 is an explanatory view of a second open state illustrating a valve open state by pressure sensing of the temperature control valve.

FIG. 5A is a cross-sectional view illustrating a configuration of a temperature control valve according to a second embodiment of the present invention, and FIG. 5B is an enlarged view of a part A of FIG. 5A.

FIG. 6A is a cross-sectional view illustrating a configuration of a temperature control valve according to a third embodiment of the present invention, and FIG. 6B is an enlarged view of a part B of FIG. 6A.

### DESCRIPTION OF PREFERRED EMBODIMENTS

The following describes a battery cooling system according to the embodiment of the present invention in detail with reference to the drawings.

### <Battery Cooling System>

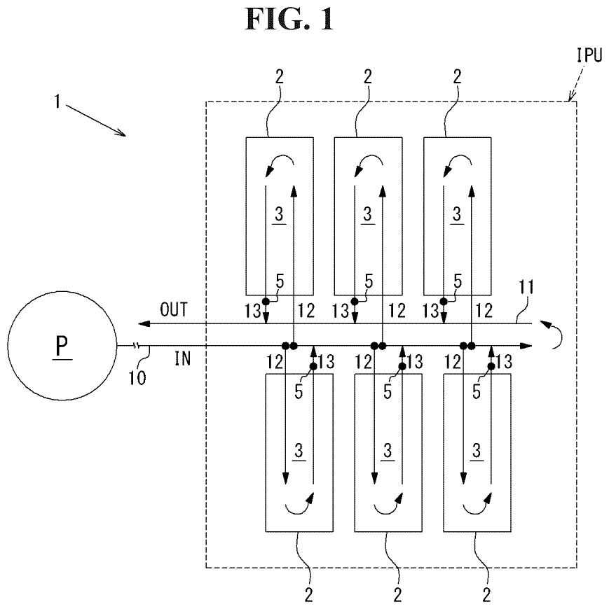

With reference to FIG. 1, a battery cooling system 1 according to the embodiment of the present invention will be described. A case of cooling a battery of an intelligent power unit (IPU) mounted under the floor of an electric vehicle will be described as an example. FIG. 1 is a schematic plan view schematically illustrating a configuration of the battery cooling system 1 according to the embodiment of the present invention.

As illustrated in FIG. 1, the battery cooling system 1 according to the embodiment of the present invention is a cooling system including a water jacket 2 configured to flow cooling water as a cooling medium to cool a battery as a main component. The battery as a cooling target of the battery cooling system 1 according to the embodiment is one including a plurality of battery packs 3, and the battery pack 3 houses a battery module, in which a plurality of battery cells are stacked and integrated, in a case.

### (Water Jacket)

A water jacket 2 according to the embodiment is, as illustrated in FIG. 1, provided for each of the battery packs 3, and one corresponding battery pack 3 is provided on each water jacket 2. Specifically, for the water jacket 2, a bottom surface of the case of the battery pack 3 is integrated with the water jacket 2. However, the water jacket 2 may be a separate body from the case of the battery pack 3, and the case of the battery pack 3 may be placed to be in contact with the water jacket 2. Basically, it is only necessary that the water jacket 2 and the battery pack 3 are provided to be in close contact or in proximity so as to quickly transfer heat for cooling.

The water jacket 2 includes a rectangular main body portion formed of a metal plate, and a supply channel and a discharge channel configured to supply the cooling water inside the main body portion. That is, as illustrated in FIG. 1, the battery cooling system 1 includes a supply main channel 10 and a discharge main channel 11, and a plurality of supply branch channels 12 and discharge branch channels 13. The supply main channel 10 and the discharge main channel 11 are main channels directly coupled to a pump P as pressure feeding means configured to pressure feed the cooling medium without a branch. The plurality of supply branch channels 12 and discharge branch channels 13 are branch channels branched from the main channel in parallel at a plurality of places and return to the main channel.

### (Temperature Control Valve)

Then, as illustrated in FIG. 1, a temperature control valve 5 is provided at an outlet of flowing out from the discharge channel of the water jacket 2 to the external discharge main channel 11. In the battery cooling system 1 according to the embodiment, the temperature control valve 5 as a wax-type thermostat is provided in the middle of the discharge branch channel 13 that returns from each of the water jackets 2 to the discharge main channel 11.

However, the temperature control valve according to the present invention is not limited to the wax-type thermostat, and may be a bellows-type thermostat in which an ether is sealed in a stretchable bellows and the ether is expanded and contracted by heat to open and close a valve. The temperature control valve according to the present invention may be a thermostat of another type, for example, an SMA-type thermostat configured to open and close a valve by a shape memory alloy. Basically, the temperature control valve according to the present invention only needs to be a temperature control valve configured to adjust a degree of opening of a valve corresponding to a temperature of a cooling medium nearby.

### <Temperature Control Valve>

### First Embodiment

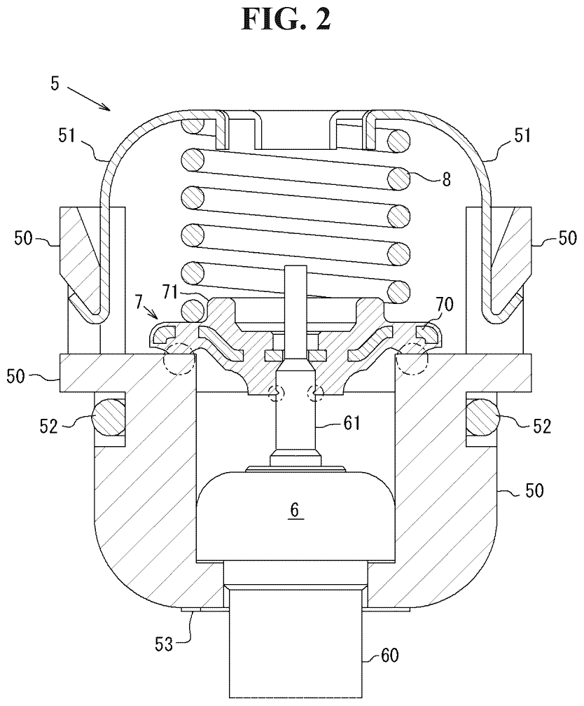

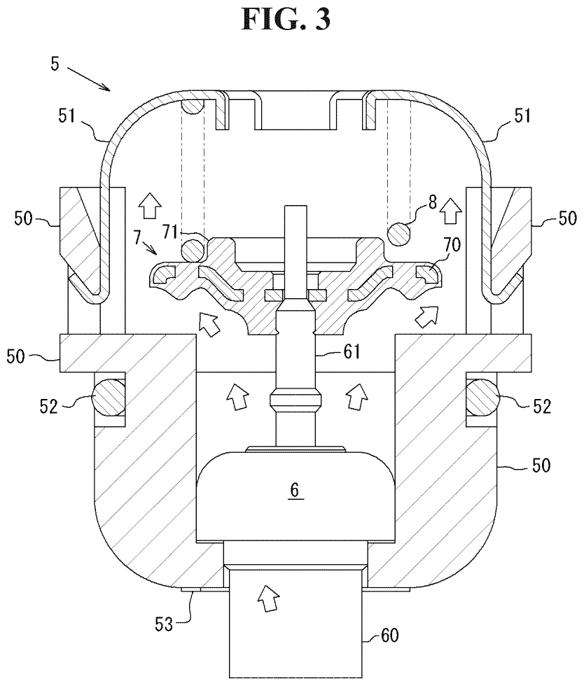

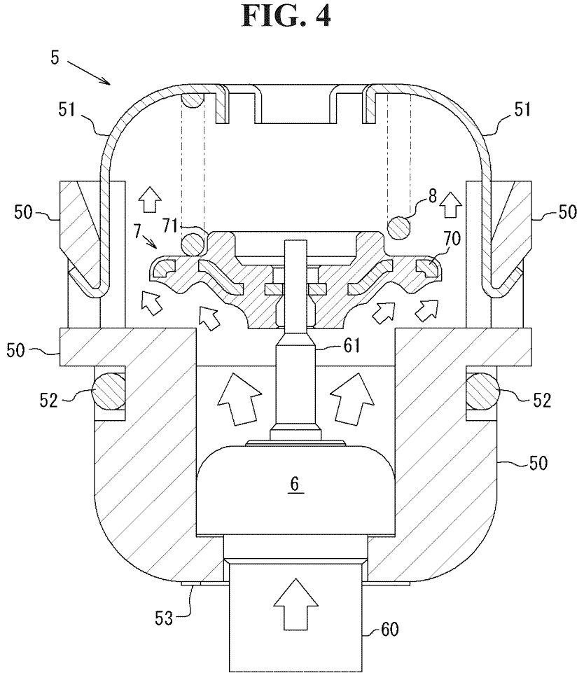

Next, with reference to FIG. 2 to FIG. 4, the temperature control valve 5 according to the first embodiment of the present invention will be described in further detail. FIG. 2 is a cross-sectional view illustrating a configuration of the temperature control valve 5 according to the first embodiment of the present invention. FIG. 3 is an explanatory view of a first open state illustrating a valve open state by temperature sensing of the temperature control valve 5, and FIG. 4 is an explanatory view of a second open state illustrating a valve open state by pressure sensing of the temperature control valve 5.

As illustrated in FIG. 2, the temperature control valve 5 is a wax-type thermostat in which a stainless steel mounting frame 51 is fitted into a cylindrical metal case 50 formed of an aluminum alloy or the like, and a wax pellet 6 is installed therein. An EPDM (ethylene-propylene-diene rubber)O-ring 52 is installed at a groove portion in the outer periphery of the case 50, and a stainless steel retaining ring 53 that fills a gap with the wax pellet 6 is attached to the bottom surface of the case 50.

The wax pellet 6 includes a housing 60 in which a paraffin wax is sealed, and a piston rod 61 configured to freely come in and out with respect to the housing 60. The temperature control valve 5 has a mechanism in which the wax is expanded to cause the piston rod 61 to project and push up a valve element 7 attached to the piston rod 61, thereby opening the valve. It is needless to say that the wax sealed in the wax pellet 6 is not limited to the paraffin wax, and only needs to be a material that is relatively large in volume change and has a predetermined thermal expansion characteristic, for example, a micro wax.

The valve element 7 includes a doughnut-shaped valve body 70 formed of a stainless steel plate as a substrate body, and the valve body 70 has a peripheral portion covered with a sealing material 71 formed of EPDM (ethylene-propylene-diene rubber). As illustrated in FIG. 2, the sealing material 71 is provided with projecting portions at a contact surface with the piston rod 61 and a lower surface as a contact surface with the case 50, which are points of leak path and surrounded by circles of one dot chain line, and thus the sealing material 71 is designed to provide complete rubber sealing to avoid leakage.

A stainless steel coil spring 8 is interposed between the valve element 7 and the mounting frame 51, and the valve element 7 is biased in a direction of the wax pellet 6 side.

As illustrated in FIG. 3, in the temperature control valve 5, when the valve is actuated to be opened by temperature sensing in a first open state, the cooling water warmed by the heat generation of the above-described individual battery pack 3 flows into the peripheral portion of the wax pellet 6 through the discharge branch channel 13, and the wax inside the housing 60 is warmed to be thermally expanded, thereby projecting the piston rod 61.

Accordingly, the valve element 7 fitted to the piston rod 61 is pushed up, the opening amount of the valve increases, and the flow rate of the cooling water increases, thus allowing effectively cooling only the battery pack 3 having the high heat generation amount by the water jacket 2.

As illustrated in FIG. 4, when the valve is actuated to be opened by pressure sensing in a second open state, the temperature control valve 5 has a pressure relief structure in which the portion of the valve element 7 fitted to the piston rod 61 comes off regardless of the projection amount of the piston rod 61. Accordingly, an abnormal pressure inside the branch channel in the water jacket 2 can be released, thus allowing protection of the whole channels of the water jacket 2 and the battery cooling system 1.

Moreover, with the temperature control valve 5 having the pressure relief structure in which the valve (valve element 7) opens to release the pressure when the pressure applied to the valve element 7 becomes a predetermined value or more, even in a temperature range before opening the valve of the thermostat, the output of the pump that pressure feeds the cooling medium can be increased as necessary to flow the cooling medium.

While the case where the fitting portion of the valve element 7 comes off from the piston rod 61 is described as the pressure relief structure of the temperature control valve 5, another pressure relief structure that the pressure is released when a pressure of certain degree or more is applied to the valve element 7, for example, the valve element 7 is deformed by the pressure and pressed to be opened, may be employed.

According to the battery cooling system 1 described above, by opening and closing the temperature control valve 5, the flow resistance of the cooling medium can be increased and decreased corresponding to the beat generation amounts of the respective battery packs 3, and the cooling medium can be distributed at the appropriate flow rate, thus allowing uniformly controlling the battery temperatures of the respective cells. Therefore, the life of the battery pack 3 and the battery can be prolonged and the durability can be improved.

According to the battery cooling system 1, since the above-described operational advantage is achieved with the temperature control valve that has been proven for long years as cooling means for internal combustion engines of an automobile and the like in which vibration possibly causes a malfunction leading to a serious accident, one that is low-price, simple, and highly durable and reliable with little malfunction can be provided.

In addition, according to the battery cooling system 1, since the temperature control valve 5 has the pressure relief structure in which the valve (valve element 7) opens to release the pressure when the pressure applied to the valve element 7 becomes a predetermined value or more, even in a temperature range before opening the valve of the thermostat, the output of the pump that pressure feeds the cooling medium can be increased as necessary to flow the cooling medium.

### Second Embodiment

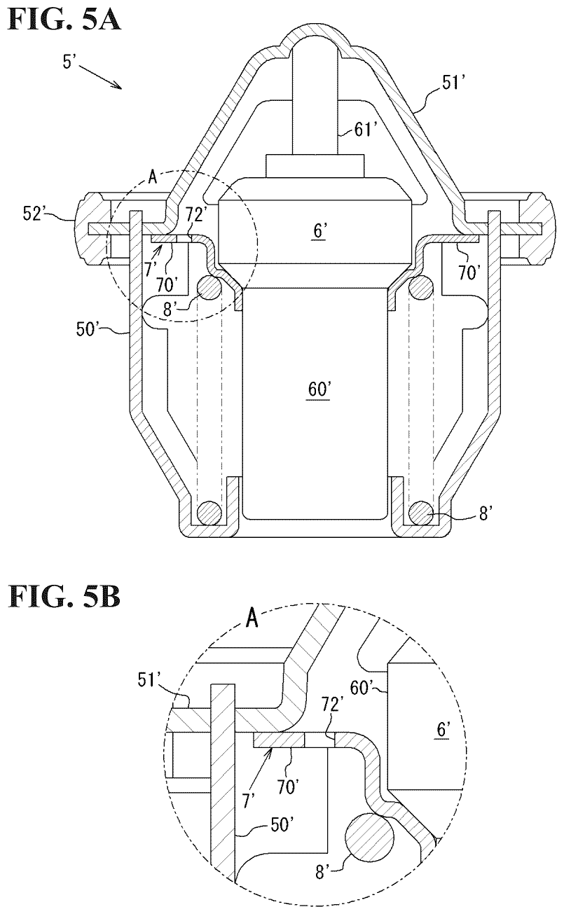

Next, with reference to FIG. 5, a temperature control valve 5′ according to the second embodiment of the present invention will be described. FIG. 5A is a cross-sectional view illustrating a configuration of the temperature control valve 5′ according to the second embodiment of the present invention, and FIG. 5B is an enlarged view of a part A of FIG. 5A. As illustrated in FIG. 5A, the temperature control valve 5′ according to the second embodiment is a wax-type thermostat in which a stainless steel cap 51′ and a ring-shaped frame body 52′ are fitted to be secured to a metal case 50′ formed of an aluminum alloy or the like, and a wax pellet 6′ is installed therein. The temperature control valve 5′ according to the second embodiment is different from the temperature control valve 5 according to the first embodiment mainly in the valve element portion.

The wax pellet 6′ includes, similarly to the wax pellet 6, a housing 60′ in which a paraffin wax is sealed, and a piston rod 61′ configured to freely come in and out with respect to the housing 60′. However, different from the temperature control valve 5, the temperature control valve 5′ has a mechanism in which the expansion of the wax projects the piston rod 61′ to push down the valve element 7′ fitted to the housing 60′, thereby opening the valve. It is needless to say that the wax sealed in the wax pellet 6′ is also not limited to the paraffin wax, and only needs to be a material that is relatively large in volume change and has a predetermined thermal expansion characteristic, for example, a micro wax.

The valve element 7′ includes a doughnut-shaped valve body 70′ formed of a stainless steel plate, and the valve body 70′ is drilled with a leak hole 72′ for flowing the cooling water as a cooling medium by a small amount (predetermined amount) enough to measure the temperature even when the valve is closed. Therefore, according to the battery cooling system 1 including the temperature control valve 5′ of the second embodiment mounted to the discharge branch channel 13, the leak hole 72′ allows the cooling water to always flow through the discharge branch channel 13 by a constant amount even when the valve of the temperature control valve 5′ is closed. Accordingly, according to the battery cooling system 1 including the temperature control valve 5′, the temperatures of the respective battery packs 3 can be always monitored by always measuring the temperature of the cooling water that has passed through the battery pack 3.

The valve element 7′ may be covered with a rubber material, such as EPDM (ethylene-propylene-diene rubber) similarly to the above-described valve element 7.

As illustrated in FIG. 5, a stainless steel coil spring 8′ is interposed between the valve element 7′ and a bottom surface of the case 50′, and the valve element 7′ is biased from the bottom surface side of the case 50′ in a direction of the wax pellet 6′ side.

### Third Embodiment

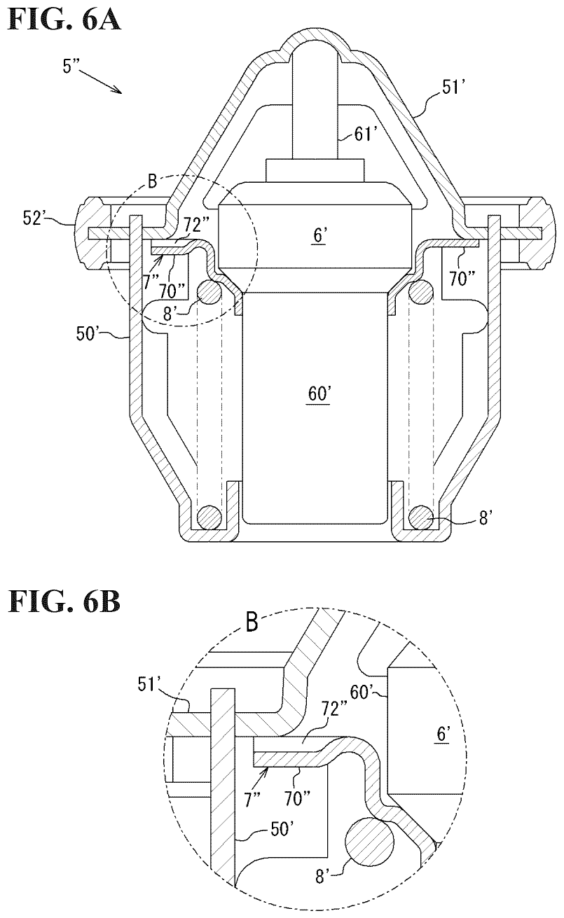

Next, with reference to FIG. 6, a temperature control valve 5″ according to the third embodiment of the present invention will be described. FIG. 6A is a cross-sectional view illustrating a configuration of the temperature control valve 5″ according to the third embodiment of the present invention, and FIG. 6B is an enlarged view of a part B of FIG. 6A. The temperature control valve 5″ according to the third embodiment is different from the temperature control valve 5′ according to the second embodiment in the valve element portion, and other configurations are approximately same. Therefore, the same reference numerals are attached to the configurations same as those of the temperature control valve 5′ according to the second embodiment, and their explanation will be omitted.

The valve element 7″ of the temperature control valve 5″ according to the third embodiment includes a doughnut-shaped valve body 70″ formed of a stainless steel plate, and the valve body 70″ is provided with, instead of the leak hole 72′, a leak groove 72″ formed by partially notching a part of the valve body 70′ to flow the cooling water by a predetermined amount even when the valve is closed. Therefore, according to the battery cooling system 1 including the temperature control valve 5″ of the third embodiment mounted to the discharge branch channel 13, the leak groove 72″ allows always monitoring the temperatures of the respective battery packs 3 by flowing the cooling water even when the valve of the temperature control valve 5″ is closed and always measuring the temperature of the cooling water that has passed through the battery pack 3. Moreover, according to the battery cooling system 1 including the temperature control valve 5″, even when the leak groove 72″ is clogged with a foreign matter, by opening the temperature control valve 5″ to open the valve element 7″, the foreign matter can be flowed out by the cooling water and removed from the leak groove 72″.

Needless to say, the valve element 7″ may be covered with a rubber material, such as EPDM (ethylene-propylene-diene rubber) similarly to the above-described valve element 7.

Instead of forming the leak groove 72″ at the valve element 7″, a leak groove may be formed by notching a part of a valve seat side, that is, the cap 51′ or the case 50′ in the illustrated configuration, with which the valve element 7″ is brought in close contact for the closure. This is because also in this case, the cooling water can be flowed even when the valve is closed, and a foreign matter can be flowed out by the cooling water and removed when the valve is opened.

While the battery cooling system 1 according to the embodiments of the present invention and the temperature control valves 5 to 5″ according to the first embodiment to the third embodiment have been described above in detail, the described or illustrated embodiments each merely indicate one embodiment embodied in carrying out the present invention. Accordingly, the technical scope of the present invention should not be interpreted in a limited way through the embodiments. Especially, while the cooling water is described as an example of the cooling medium, obviously, the cooling medium only needs to include a fluid having an appropriate thermal capacity enough to cool the battery pack.

### DESCRIPTION OF REFERENCE SIGNS

1: Battery cooling system
10: Supply main channel
11: Discharge main channel
12: Supply branch channel
13: Discharge branch channel
2: Water jacket
3: Battery pack
5, 5′, 5″: Temperature control valve
50, 50′: Case
51: Mounting frame
51′: Cap
52: O-ring
52′: Frame body
53: Retaining ring
6, 6′: Wax pellet
60, 60′: Housing
61, 61′: Piston rod
7, 7′, 7″: Valve element
70, 70′, 70″: Valve body
71: Sealing material
72: Leak hole
72″: Leak groove
8, 8′: Coil spring
P: Pump (pressure feeding means)

1. A battery cooling system for cooling a battery including a plurality of battery packs by a jacket, the jacket including a branch channel that branches from a main channel and returns to the main channel, the main channel being directly coupled to pressure feeding means that pressure feeds a cooling medium, the battery cooling system comprising
a temperature control valve provided at the branch channel through which the cooling medium flows out from the channel of the jacket to an outside and returns to the main channel, the self-powered temperature control valve adjusting a degree of opening of a valve corresponding to a temperature of the cooling medium nearby.

2. The battery cooling system according to claim 1, wherein
the temperature control valve is a wax-type thermostat.

3. The battery cooling system according to claim 1, wherein
the temperature control valve is a bellows-type thermostat.

4. The battery cooling system according to claim 1, wherein
the temperature control valve is an SMA-type thermostat.

5. The battery cooling system according to claim 1, wherein
the temperature control valve is provided with a leak hole.

6. The battery cooling system according to claim 5, wherein
the leak hole is a leak groove formed at a part of a valve seat or a valve element.

7. The battery cooling system according to claim 1, wherein
the temperature control valve has a pressure relief structure that opens when a pressure becomes a predetermined value or more.
